(19) United States
(12) Patent Application Publication
(10) Pub. No.: US 2016/0153916 A1
(43) Pub. Date: Jun. 2, 2016

(54) METHOD FOR INSPECTING SCREEN

(71) Applicants: Inventec (Pudong) Technology Corporation, Shanghai (CN); INVENTEC CORPORATION, TAIPEI CITY (TW)

(72) Inventor: Sheng-Lin LIN, TAIPEI CITY (TW)

(21) Appl. No.: 14/681,058

(22) Filed: Apr. 7, 2015

(30) Foreign Application Priority Data
Nov. 27, 2014 (CN) 201410709626.X

(51) Int. Cl. G01N 21/88; H04N 9/12; G06K 9/62; G06T 7/00

(52) U.S. Cl. CPC G01N 21/8851; G06T 7/0004; H04N 9/12; G06K 9/6202; G06T 2207/30108

(57) ABSTRACT

A method for inspecting a screen includes sending image information to a screen, in which the screen includes plural color channels corresponding to colors, and the image information includes plural inspecting patterns corresponding to the colors of the color channels; displaying the inspecting patterns on the screen at the same time; capturing a picture on the screen by a capture device; fetching plural processing data by analyzing the captured picture according to the colors of the color channels; dichotomizing the processing data by brightness to obtain plural binary image data; and comparing the shapes shown by the binary image data to the shapes of the inspecting patterns of the image information.

### RELATED APPLICATIONS

This application claims priority to Chinese Patent Application Number 201410709626.X, filed Nov. 27, 2014, which is herein incorporated by reference.

### BACKGROUND

1. Field of Invention

The present invention relates to a method for inspecting a screen.

2. Description of Related Art

Display screens are applicable to various display devices, such as televisions, computers, smart phones, etc. Recently, as the development of the display devices grows prosperously, the fabrication of the display screens has drawn much attention.

The process for fabricating a display screen includes various processing steps, such as electrode coating, film plating, rubbing, substrate bonding, liquid crystal dispensing, etc. At the end of the fabrication process, the fabricator has to ensure if the screen can be operated normally. Therefore, there is an inspecting step at the end of the series of the processing steps, and the inspecting step is used to inspect whether the screen fabricated can be operated normally.

### SUMMARY

The invention provides a method for inspecting a screen, in which a capturing device with a general resolution is used to capturing a picture on the screen to be inspected, and after several analysis steps, shape comparison is used to determine whether the screen can be operated normally. The method may obtain a good inspecting result without needing a high-resolution picture or a high-resolution capturing device.

According to one embodiment of the present invention, a method for inspecting a screen includes: (a) sending image information to the screen, wherein the screen includes plural color channels, and each of the color channels is corresponding to a color, and the image information includes plural inspecting patterns corresponding to the colors of the color channels; (b) displaying the inspecting patterns on the screen at the same time; (c) capturing a picture on the screen by a capture device; (d) fetching plural processing data by analyzing the captured picture according to the colors of the color channels; (e) dichotomizing the processing data by brightness to obtain plural binary image data; and (f) comparing the shapes shown by the binary image data with the shapes of the inspecting patterns in the image information.

In one or more embodiments of the present invention, the inspecting patterns are sent to the screen by the color channels corresponding to the colors.

In one or more embodiments of the present invention, centers of the inspecting patterns are overlapped in step (b).

In one or more embodiments of the present invention, the colors of the inspecting patterns are red, green, and blue respectively, and the color channels are a red channel, a green channel, and a blue channel respectively, and the number of the inspecting patterns, the number of the processing data, and the number of the binary image data are three respectively.

In one or more embodiments of the present invention, the processing data are dichotomized according to different brightness at step (e).

In one or more embodiments of the present invention, the shapes of the inspecting patterns are different.

In one or more embodiments of the present invention, the method includes (g) determining that the screen inspection is passed when the shapes shown by the binary data are similar to the shapes of the inspecting patterns.

In one or more embodiments of the present invention, the method includes (h) determining that the screen inspection is failed when one of the shapes shown by the binary data is different from the corresponding one of the shapes of the inspecting patterns.

In one or more embodiments of the present invention, the method includes (i) decreasing respective resolutions of the binary image data.

In one or more embodiments of the present invention, the method includes (j) aligning the capturing device with the screen before step (c) is performed.

It is to be understood that both the foregoing general description and the following detailed description are by examples, and are intended to provide further explanation of the invention as claimed.

### BRIEF DESCRIPTION OF THE DRAWINGS

The invention can be more fully understood by reading the following detailed description of the embodiment, with reference made to the accompanying drawings as follows:

FIG. 1 is a flow chart of a method for inspecting a screen according to one embodiment of the present invention;

FIG. 2A is a schematic view showing a step of a method for inspecting a screen according to one embodiment of the present invention;

FIG. 2B is a schematic view showing image information according to one embodiment of the present invention;

FIG. 2C is a schematic view showing another step of the method for inspecting the screen according to one embodiment of the present invention;

FIG. 2D is a real captured picture according to one embodiment of the present invention;

FIG. 2E is a schematic view showing processing data according to one embodiment of the present invention; and

FIG. 2F is a schematic view showing binary image data according to one embodiment of the present invention.

### DETAILED DESCRIPTION

Reference will now be made in detail to the present embodiments of the invention, examples of which are illustrated in the accompanying drawings. Wherever possible, the same reference numbers are used in the drawings and the description to refer to the same or like parts.

It should be noted that, though the figures of embodiments of the present invention are not presented in colors, a portion of the figures are colorful originally. For simplifying the explanation of the patent application, the figures are presented in black-and-white herein while the black-and-white figures do not affect the concepts and scope of the present invention.

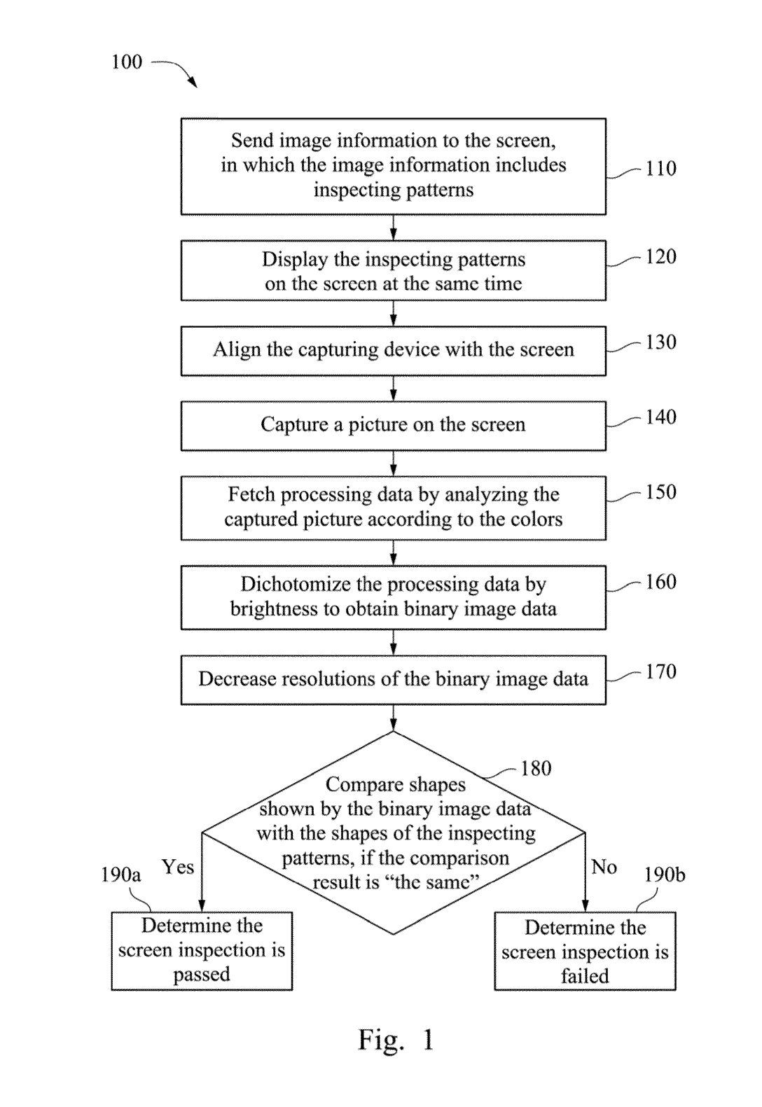

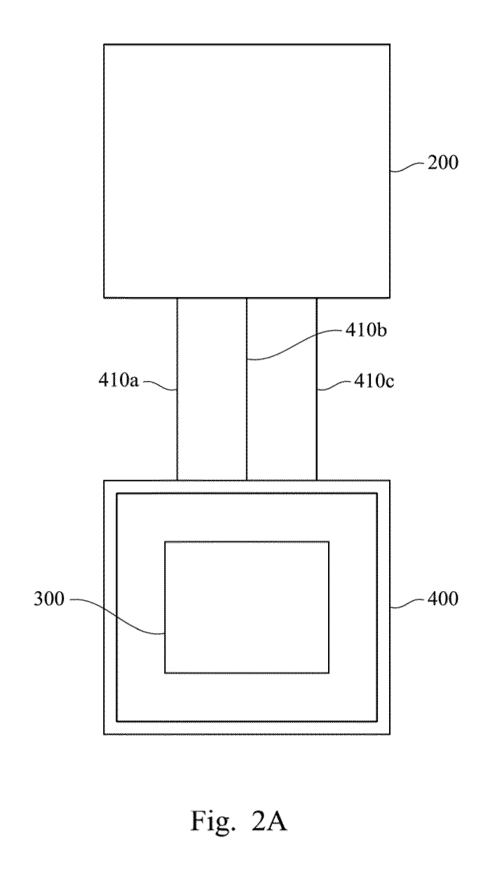

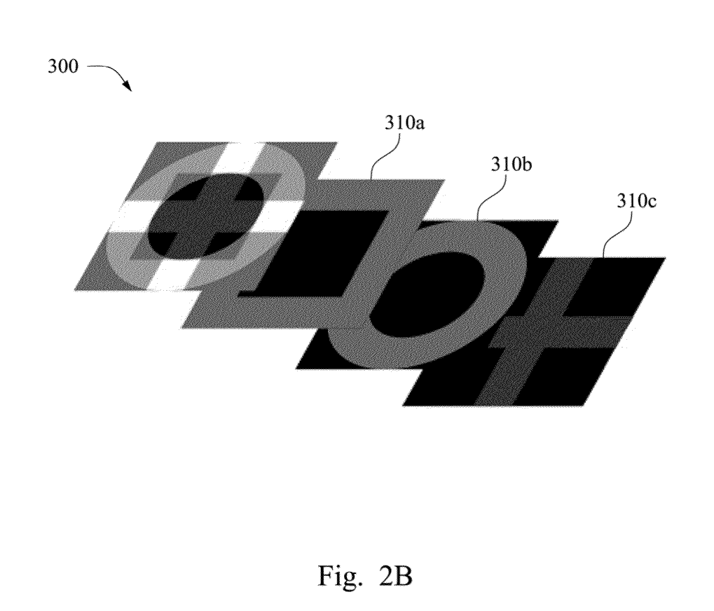

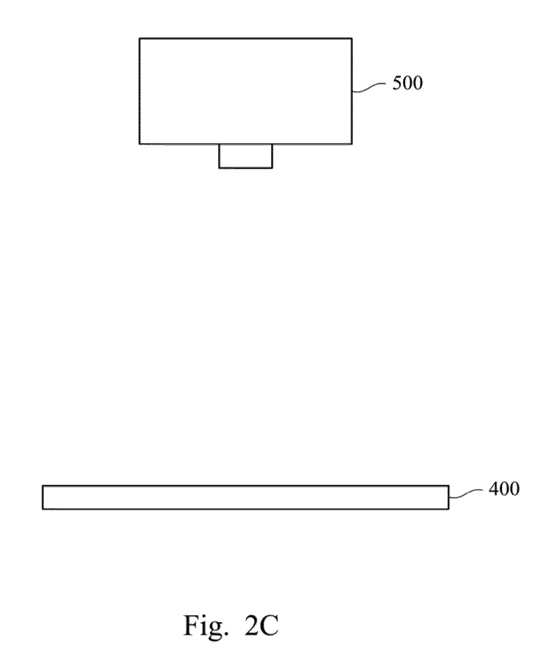

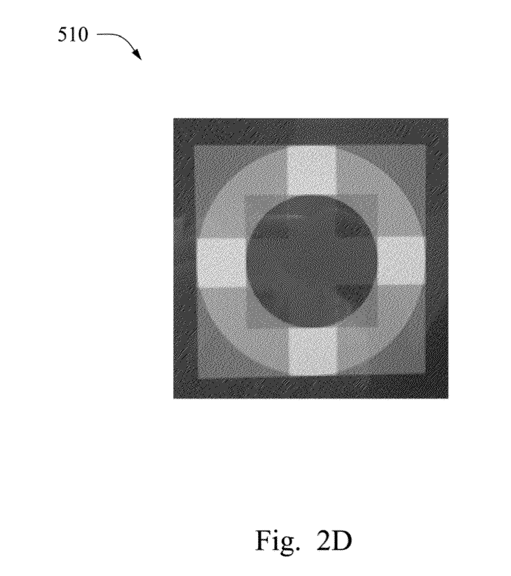

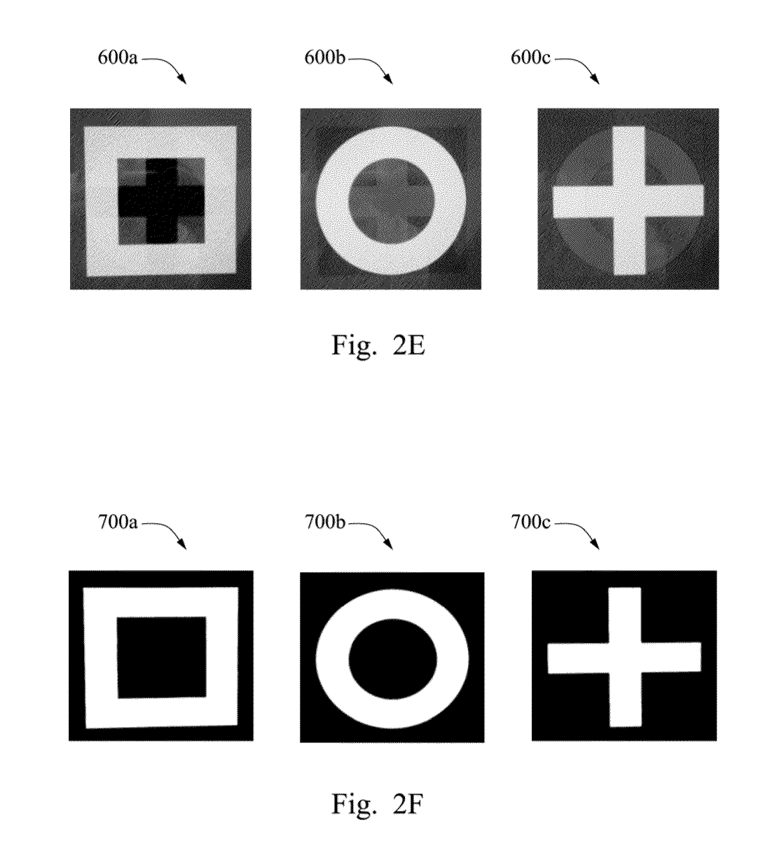

FIG. 1 is a flow chart of a method 100 for inspecting a screen according to one embodiment of the present invention. Typically, the method 100 is to inspect the screen through a computer and a capturing device. The method 100 includes plural steps 110-180, 190a, and 190b. Herein, for clear illustration, the following description is explained by using plural steps of the method 100 in FIG. 1 accompanying with FIG. 2A to FIG. 2F which are schematic views showing steps, image information, a captured picture, processing data, and binary image data, and will be illustrated step by step.

Reference is made to FIG. 1, FIG. 2A, and FIG. 2B. FIG. 2A is a schematic view showing a step of the method for inspecting the screen according to one embodiment of the present invention. FIG. 2B is a schematic view showing the image information according to one embodiment of the present invention. The method 100 for inspecting the screen starts from step 110, in which the image information 300 is sent to the screen 400 by a computer 200. The image information 300 includes plural inspecting patterns 310a, 310b, and 310c corresponding to different colors. The screen 400 to be inspected includes plural color channels 410a, 410b, and 410c corresponding to different colors. Typically, the colors of the inspecting patterns 310a, 310b, and 310c are corresponding to the colors of the color channels 410a, 410b, and 410c.

Generally, the screen is configured with red, green, and blue color channels. Therefore, in one or more embodiments of the present invention, the color of the inspecting pattern 310a is designed to be red, the color of the inspecting pattern 310b is designed to be green, and the color of the inspecting pattern 310c is designed to be blue. The screen 400 includes the red color channel 410a, the green color channel 410b, and the blue color channel 410c.

In one or more embodiments of the present invention, the inspecting patterns 310a, 310b, and 310c are sent to the screen 400 by the respective color channels 410a, 410b, and 410c corresponding to the colors. For example, the computer 200 sends the inspecting pattern 310a in the image information 300 to the screen 400 through the color channel 410a, and sends the inspecting pattern 310b in the image information 300 to the screen 400 through the color channel 410b, and sends the inspecting pattern 310c in the image information 300 to the screen 400 through the color channel 410c.

Next, at step 120 of the method 100, the screen 400 displays the inspecting patterns 310a, 310b, and 310c on the screen at the same time. In one or more embodiments of the present invention, respective centers of the inspecting patterns 310a, 310b, and 310c are overlapped, such that the following test are performed at the same position of the screen 400 without needing to adjust the position of the capturing device according to the positions of the inspecting patterns 310a, 310b, and 310c sequentially. In one or more embodiments of the present invention, the shapes of the inspecting patterns 310a, 310b, and 310c can be different. For example, in this embodiment, the inspecting pattern 310a shows a square, the inspecting pattern 310b shows a circle, the inspecting pattern 310c shows a cross, and the centers of the square, the circle, and the cross are overlapped.

Reference is made to FIG. 1 and FIG. 2C. FIG. 2C is a schematic view showing another step of the method for inspecting the screen according to one embodiment of the present invention. At step 130 of the method 100, the capturing device 500 is aligned with the screen 400. Herein, whether the capturing device 500 is precisely focused does not need to be considered, as long as the capturing device 500 is focused roughly. In other words, the distance between the capturing device 500 and the screen 400 can be approximately equal to the focal length of the capturing device 500, and the capturing device 500 does not need to be located at a determined position accurately. Because the method 100 of the embodiments of the present invention is accomplished by fuzzy matching, such as shape matching, the resolution is not an important factor, such that the method 100 is applicable to low-resolution images, and whether the capturing device 500 is focused precisely does not affect the inspecting result.

Then, reference is made to FIG. 1, FIG. 2C, and FIG. 2D. FIG. 2D is a real captured picture 510 according to one embodiment of the present invention. At step 140 of the method 100, the captured device 500 captures the picture on the screen 400 (as shown in FIG. 2D), and the captured information is referred as the captured picture 510.

Then, reference is made to FIG. 1, FIG. 2D, and FIG. 2E. At step 150 of the method 100, plural processing data 600a, 600b, and 600c are fetched by analyzing the captured picture 510 according to the colors. Herein, color analysis computer software is utilized to attain the color data of the captured picture 510.

Regarding the color analysis using software to acquire the color data, because the method 100 is used for detecting whether the screen is operated normally, the inspection should be based on whether the color channels 410a, 410b, and 410c (referring to FIG. 2A) of the screen to be inspected can present the inspecting patterns 310a, 310b, and 310c correctly. As a result, in this embodiment, the computer can be used to analyze the captured picture 510 by adjusting saturation and hue according to the colors of the color channels 410a, 410b, and 410c (referring to FIG. 2A). For example, the data in a range of hue and saturation are fetched as processing data 600a, the data in another range of hue and saturation are fetched as processing data 600b, and the data in another range of hue and saturation are fetched as processing data 600c. The ranges are corresponding to the colors of the color channels 410a, 410b, and 410c (referring to FIG. 2A) or according to the colors of inspecting patterns 310a, 310b, and 310c (referring to FIG. 2B) respectively.

Typically, the processing data 600a, 600b, and 600c are gray scale images. Also, since the color difference between the capturing device and the screen, and the saturation and hue chosen in the computer analyzing, the processing data 600a, 600b, and 600c can be dependent. As shown in the figure, the processing data 600a, 600b, and 600c not only present the data about the square, the circle, and the cross, but also present other noise.

Next, reference is made to FIG. 1, FIG. 2E, and FIG. 2F. FIG. 2E is a schematic view showing the processing data according to one embodiment of the present invention. At step 160 of the method 100, the processing data 600a, 600b, and 600c (referring to FIG. 2E) are respectively dichotomized by brightness to obtain binary image data 700a, 700b, and 700c which are black and white data. This step is used to filter out the noise of the processing data 600a, 600b, and 600c, and thus to highlight the shapes. For example, assuming the brightness values of the processing data 600a, 600b, and 600c are represented by color levels “0-255”, dichotomization can be performed on the processing data 600a by using a color level (brightness) value “127” as a center. If a color level (brightness) value of a certain position of the processing data 600a is “120”, then it is reduced to “0” after the dichotomization. If a color level (brightness) value of another position of the processing data 600a is “140”, then it is increased to “255” after the dichotomization. In this way, the processing data 600a can be converted to the binary image data 700a.

In one or more embodiments of the present invention, according to the colors corresponding to the processing data 600a, 600b, and 600c, the processing data 600a, 600b, and 600c can be dichotomized by using the same brightness. On the other hand, the processing data 600a, 600b, and 600c can be dichotomized by using different brightness. For example, it can be configured to perform dichotomization on the processing data 600b by using a color level (brightness) value “150” as a center. If a color level (brightness) value of a position of the processing data 600b is “140”, then it is reduced to “0” after the dichotomization. If a color level (brightness) value of another position of the processing data 600b is “160”, then it is increased to “255” after the dichotomization. In this way, the processing data 600b can be converted to the binary image data 700b, and the processing data 600a, 600b are dichotomized by using different brightness.

Then, the method 100 can includes step 170 for decreasing the resolutions of the binary image data. This step is used to reduce the size of the image file during the process of the method 100 for inspecting the screen. Since the method 100 for inspecting the screen of the embodiments of the present invention uses shape matching to achieve its inspection purpose and the shape matching is fuzzy matching, the resolution is not an important factor, such that the resolution of data used in the method 100 can be lowered without affecting the matching results. Step 170 is not a necessary step, and can be skipped to perform the step 180 directly. Furthermore, a step of decreasing the resolutions of the captured pictures or the processing data 600a, 600b, and 600c can also be added between step 140 and step 150 or between step 150 and step 160, thereby decreasing the size of the image file during the process of the method 100 for inspecting the screen.

Reference is made to FIG. 1, FIG. 2B, and FIG. 2F, FIG. 2F is a schematic view showing the binary image data according to one embodiment of the present invention. Step 180 of the method 100 is performed to compare the shapes shown by the binary image data 700a, 700b, and 700c with the shapes of the inspecting patterns 310a, 310b, and 310c in the image information 300. If the comparison result shows that the shapes are the same or similar, than step 190a is performed. If the comparison result shows that the shapes are different, then step 190b is performed. In detail, at step 110, when the computer 200 (FIG. 2A) sends the inspecting pattern 310a to the screen, the computer 200 obtains the shape of the inspecting pattern 310a. After the capture device captures the picture of the screen displaying the inspecting pattern 310a and the brightness and the color channels are analyzed, the computer 200 can obtain the shape shown by the binary image data 700a. The computer can compare the shape of the inspecting patterns 310a with the shape shown by the binary image data 700a to ensure if the screen can display normally.

At step 190a, if it is determined that the shapes shown by the binary image data 700a, 700b, and 700c are similar to or the same as the shapes of the inspecting patterns 310a, 310b, and 310c of the image information, then the screen 400 is determined to pass inspection. Herein, it is noted that the condition for determining whether the screen pass inspection is that all of the three comparison results shows “the same shapes” or “similar shapes.” For example, the comparison result between the binary image data 700a and the inspecting patterns 310a should show that their shapes are the same or similar; the comparison result between the binary image data 700b and the inspecting patterns 310b should show that their shapes are the same or similar; and the comparison result between the binary image data 700c and the inspecting patterns 310c should show that their shapes are the same or similar, and then, the screen can be determined to pass inspection.

At step 190b, if one of the shapes shown the binary image data 700a, 700b, and 700c are different from the one of shapes of the inspecting patterns 310a, 310b, and 310c corresponding to the binary image data 700a, 700b, and 700c, then the screen is determined to fail inspection. For example, the comparison result between the binary image data 700a and the inspecting patterns 310a shows that their shapes are similar or the same; the comparison result between the binary image data 700b and the inspecting patterns 310b shows that their shapes are similar or the same; and the comparison result between the binary image data 700c and the inspecting patterns 310c shows that their shapes are different, and then the screen is determined to fail inspection.

In one or more embodiments of the present invention, since the screen sends image information through red, green, and blue color channels, a step of detecting whether the color channels of the screen operate normally is performed by designing the colors of the inspecting patterns to be red, green, and blue respectively. As a result, corresponding to the three color channels of the screen, the number of the inspecting patterns, the number of the processing data, and the number of the binary image data are three respectively. However, the settings of numbers or colors do not intend to limit the scope of the present invention, one skilled in the art can modify the number of the inspecting patterns of the image information and the methods according to the properties of the screen.

The invention provides a method for inspecting screens. By capturing a picture of the screen by a capturing device with a general resolution, and analyzing the captured picture by plural steps, the screen can be determined to pass or fail inspection by shape matching. The method offers a good inspecting result without needing a high-resolution picture or a high-resolution capturing device.

Although the present invention has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A method for inspecting a screen, the method comprising:
(a) sending image information to the screen, wherein the screen includes a plurality of color channels, and each of the color channels is corresponding to a color, and the image information comprises a plurality of inspecting patterns corresponding to the colors of the color channels;
(b) displaying the inspecting patterns on the screen at the same time;
(c) capturing a picture on the screen by a capture device;
(d) fetching a plurality of processing data by analyzing the captured picture according to the colors of the color channels;
(e) dichotomizing the processing data by brightness to obtain a plurality of binary image data; and
(f) comparing shapes shown by the binary image data with shapes of the inspecting patterns in the image information.

2. The method of claim 1, wherein the inspecting patterns are sent to the screen respectively by the color channels corresponding to the colors.

3. The method of claim 1, wherein a plurality of centers of the inspecting patterns are overlapped in step (b).

4. The method of claim 1, wherein the colors of the inspecting patterns are red, green, and blue respectively, and the color channels are a red channel, a green channel, and a blue channel respectively, and the number of the inspecting patterns, the number of the processing data, and the number of the binary image data are three respectively.

5. The method of claim 1, wherein the processing data are dichotomized according to different brightness at step (e).

6. The method of claim 1, wherein the inspecting patterns are in different shapes.

7. The method of claim 1, further comprising:
(g) determining that the screen inspection is passed when the shapes shown by the binary data are similar to the shapes of the inspecting patterns respectively.

8. The method of claim 1, further comprising:
(h) determining that the screen inspection is failed when one of the shapes shown by the binary data are different from the corresponding one of the shapes of the inspecting patterns.

9. The method of claim 1, further comprising:
(i) decreasing respective resolutions of the binary image data.

10. The method of claim 1, further comprising:
(j) aligning the capturing device with the screen before step (c) is performed.
